(19) United States
(12) Patent Application Publication
(10) Pub. No.: US 2002/0087397 A1
(43) Pub. Date: Jul. 4, 2002

(54) Buying, selling, and marketing advertisements

(76) Inventor: Sam Mazza, Fort Lee, NJ (US)

Correspondence Address: PILLSBURY WINTHROP, LLP, P.O. BOX 10500, MCLEAN, VA, 22102, US

(21) Appl. No.: 09/749,608

(22) Filed: Dec. 28, 2000

(51) Int. Cl. G06F 17/60

(52) U.S. Cl. 705/14

(57) ABSTRACT

A method and system is provided for buying, selling, and marketing advertisement. Tagged advertisements are sent, along with tagged content, from a content provider to a content delivery mechanism. Upon receiving the tagged content with tagged advertisements, the content delivery mechanism then sends the tagged content and tagged advertisements to a content user.

### BACKGROUND

1. Reservation of Copyright

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

2. Field of the Invention

The claimed inventions generally relate to marketing and advertising. More specifically, the claimed inventions relate to selective advertising to targeted audiences.

3. General Background and Related Art

Advertisement is a major marketing tool. From an advertiser's point of view, the goal of advertising is to deliver advertisement to a targeted audience in an effective manner. Different products appeal to different groups of a general audience. One important task of an advertiser is to identify the interests of different groups of a general audience and to target each group with appropriate advertisements.

From the point of view of the audience, watching a desired advertisement can provide needed and practical information. For example, if a consumer wants to buy a car, he may wish to view car advertisements to learn about various features that may be offered. On the other hand, a consumer who wants to buy furniture probably will not pay attention to a car advertisement. If the consumer's interest is known, it helps an advertiser to direct appropriate advertisements to the right group of a general audience.

Most advertisements are broadcast to a wide audience with little effort to select a sub-group of a general audience to be targeted. The classification is mainly based on, for example, age, gender, or profession. Such strategy often does not achieve effective marketing because it ignores the difference within each group. For example, people within the same age group may have very different interests. People from different gender groups may have common interests in sports cars.

### BRIEF DESCRIPTION OF THE DRAWINGS

Exemplary embodiments of the claimed inventions will be described in detail with reference to the drawings, in which like reference numerals represent similar parts throughout the several views of the drawings, and wherein:

FIG. 1 is a high level block diagram of a first embodiment of the invention, in which advertisement is selected based on users' preference information;

FIG. 2 is an exemplary flowchart of the processing of the first embodiment of the invention;

FIG. 3 is an exemplary block diagram, in which users' preference information is acquired;

FIG. 4 is an exemplary flowchart of a process to acquire users' preference information;

FIG. 5 is a high level diagram of a content provider, in which advertisement is selected based on users' preference information and delivered with user requested content;

FIG. 6 is an exemplary flowchart of a content provider to deliver content with advertisement selected based on users' preference information;

FIG. 7 is a high level block diagram of a second embodiment of the invention, in which advertisement is selected based on users' preference information;

FIG. 8 is an exemplary flowchart of the processing of the second embodiment of the invention;

FIG. 9 is a detailed block diagram of an advertisement server;

FIG. 10 shows an exemplary flowchart of the portion of an advertisement server in which a user's preference information is used to select advertisement;

FIG. 11 is a more detailed block diagram of a system in which an advertisement server builds a database for users' preference information by collaborating with a service provider; and

FIG. 12 is an exemplary flowchart for building a database for users' preference information.

### DETAILED DESCRIPTION

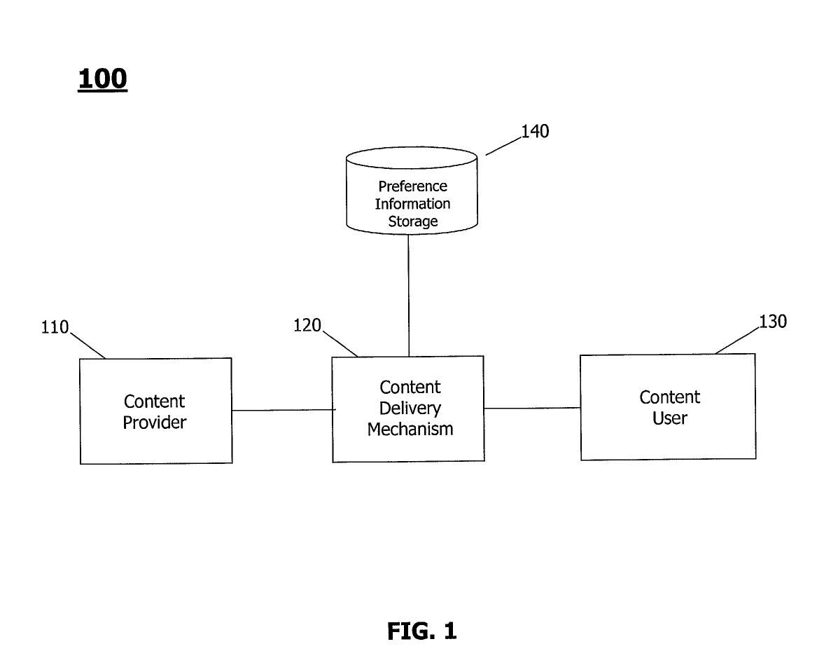

FIG. 1 is a high level block diagram of a system 100, in which advertisement, sent along with content to a content user, is selected based on users' personal preference. System 100 comprises a content provider 110, a content delivery mechanism 120, a preference information storage 140, and a content user 130. In FIG. 1, the content provider 110 provides content, together with advertisements to the content user 130 via the content delivery mechanism 120, where the content and the advertisements may be filtered based on the preference information of the content user 130 stored in preference information storage 140.

The content provider 110 may connect to a plurality of content users (not shown). The content delivery mechanism 120 is, in this embodiment of the invention, specific to the content user 130. That is, when a plurality of content users are present, each content user is connected to a different content delivery mechanism. One example of such a content delivery mechanism is a set top box.

System 100 may operate in various modes. For example, system 100 may operate in a broadcast mode, in which the content provider 110 sends content and associated advertisements to the content user 130 without concerning about what the content user 130 desires. When content, coupled with advertisements, is sent downstream to the content user 130, the content delivery mechanism 120 may retrieve the preference information, indicating the advertisement preference of the content user 130, from the preference information storage 140 and filters the advertisements to retain only the ones that are consistent with the user's preference.

A different operating mode of system 100 is demand driven. In this mode, content as well as advertisements are selected by the content provider 110 based on both user's request for the content and the preference information associated with the content user 130. In this mode, the content user 130 issues a request for desired content to the content delivery mechanism 120. When the request is received by the content delivery mechanism 120, the preference information with respect to advertisement associated with the content user 130 may be gathered, either from the user or by retrieving from the preference information storage 140, and sent along with the request from the content delivery mechanism 120 to the content provider 110. Based on the request and the preference information, the content provider 110 identifies desired content, selects the advertisements consistent with the preference of the content user 130, and sends the desired content with the selected advertisements to the content user 130 via the content delivery mechanism 120.

The content provider 110 may be a content generator or a content dealer. Examples of a content provider include a broadcaster, a cable operating company, or a web site. The content provider 110 may offer various types of content such as movie, news, or sports programs. The content provider 110 may also insert advertisements in content and send advertisements downstream as part of content. As described earlier, the content provider 110 may sends content, coupled with advertisements, in a broadcast mode such as in a TV scenario, or it may provide content based on demand such as paper view movie in cable services.

The content user 130 refers to a single content receiving destination where content may be sent to. An example of such a destination includes a TV connected to a cable service (content provider) via a set top box (content delivery mechanism). Even though such a content receiving destination may have more than one actual users (e.g., multiple viewers at one TV site), they are referred herein as a single content user. That is, the definition of a content user herein corresponds to a single content receiving destination. The content user 130 may operate in a passive mode or an active mode. The passive mode refers to a scenario in which the content user 130 views whatever contents that are sent downstream. For example, viewers of conventional TV programs are passive users. This mode may correspond to the broadcast mode of the content provider 110.

In an active mode, the content user 130 may control what is sent downstream. In system 100, the content user 130 may control both the content as well as the advertisements that are sent downstream. The former (content) may be controlled by issuing requests to the content provider 110 that specify desired content. The latter (advertisements) is controlled by applying the user's preference with respect to the types of advertisement (or no advertisement) in selecting the advertisements to be inserted into the content. The active mode of a content user may correspond to the on-demand mode of the content provider 110.

The content delivery mechanism 120 may be a set top box or a special purpose interface between the content provider 110 and the content user 130. In a demand driven mode, a user's request is acquired and sent to the content provider 110 via the content delivery mechanism 120. At the same time, the user's preference for advertisement may be acquired, also via the content delivery mechanism 120, either on-line from the user or by retrieving pre-stored preference information from the preference information storage 140. Such acquired preference information is then sent, together with the request, to the content provider 110.

In system 100, the content delivery mechanism 120 is responsible for acquiring, storing, and retrieving preference information. In addition, the content delivery mechanism 120 may also filter the content and advertisements. For example, in a broadcast situation, content and advertisements sent downstream to a particular content delivery mechanism may include the content and advertisement that are not what the corresponding user desires. Since the content delivery mechanism has access to the user's preference information, it may utilize such information to filter out the content and advertisements that are inconsistent with the user's preference.

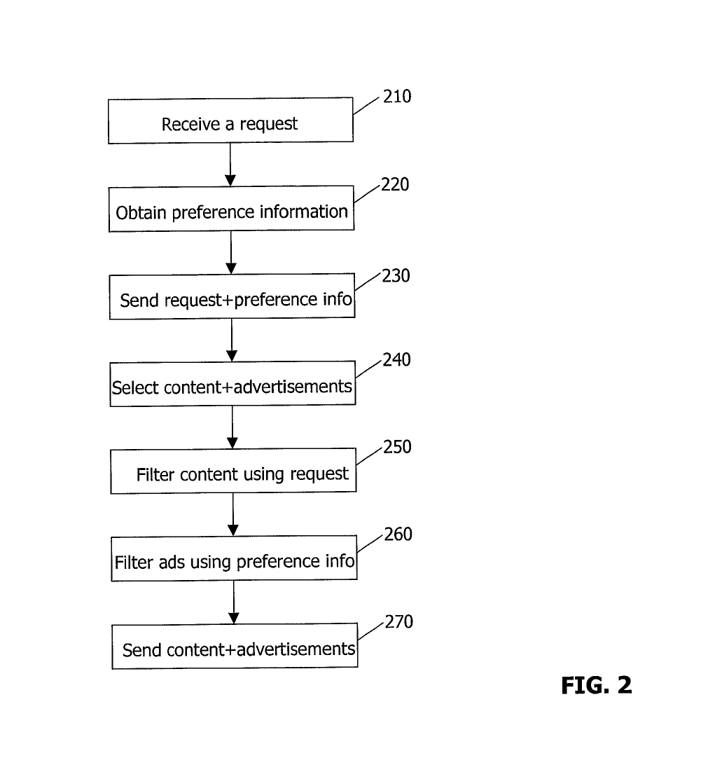

FIG. 2 shows an exemplary flowchart that describes a process in which advertisements are selected based on users' preference information and sent, by the content provider 110, along with the content requested by the content user 130. In FIG. 2, a user's request (for content) is first received at act 210 from the content user 130 by the content delivery mechanism connected to the content user 130. A user's request may specify the desired type of content. Examples of desired content include a movie with a particular name or a particular sports program played on a specified day.

The preference information with respect to advertisement associated with the content user 130 is obtained at act 220. Such preference information may be specified in terms of categories such as sporting goods category or cooking equipment category. The preference information may also be specified in terms of the maximum number of advertisements viewed at one time. Another example of preference information includes the frequency of viewing a particular category of advertisements.

Preference information may be obtained via different means. For example, the content user 130 may provide the preference information with the request. The user may also pre-record his/her preference information in a database so that such information may be retrieved whenever it is needed. Preference information may also be generated, for example, by a personalized profile building mechanism that estimates a user's preference by monitoring the user's content consumption pattern.

Once both the request and the preference information are obtained, they are sent at act 230 from the content delivery mechanism 120 to the content provider 110. Up on receiving the request and the preference information, the content provider 110 selects, at act 240, appropriate content and advertisements and sends them to the content delivery mechanism 120.

When receiving the content, the content delivery mechanism 120 filters, at act 250, the content so that the content that fits the request is further sent to the content user 130. Similarly, advertisements are filtered, at act 260, by the content delivery mechanism 120 so that the advertisements that are consistent with the user's preference are sent to the content user 130. The filtering may be necessary because the content provider 110 may send various content and advertisements requested by different content users through a common network pipe. In this case, the content delivery mechanism associated with each different content user may perform filtering to ensure that the corresponding content user receives what is asked for. Finally, the filtered content and advertisements are sent at act 270 to the content user 130.

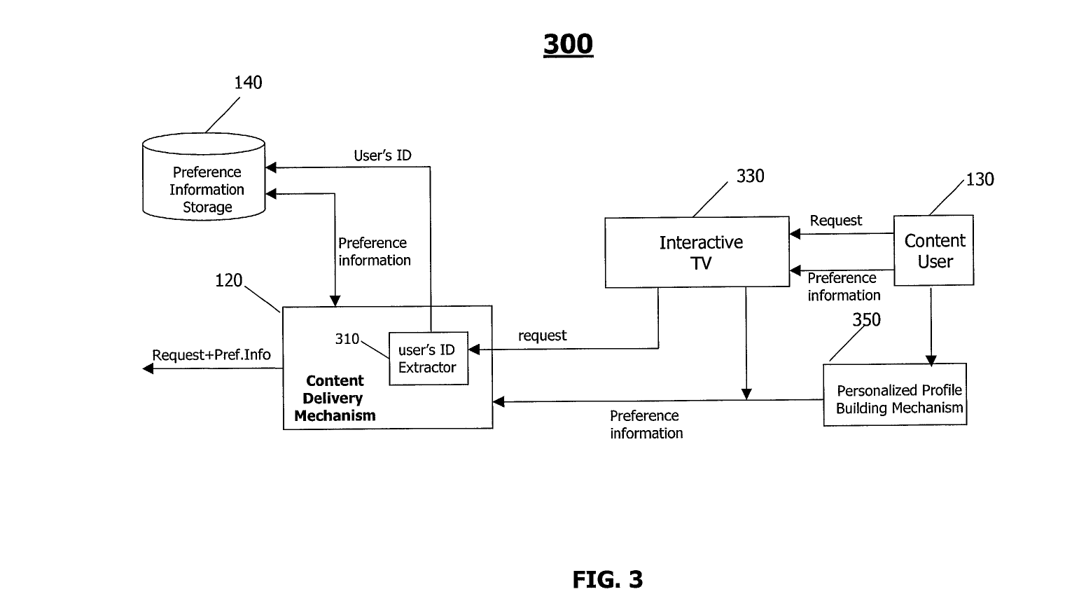

FIG. 3 is an exemplary high level block diagram in which the content delivery mechanism 120 acquires users' preference information. System 300 comprises the content user 130, an interactive TV 330, a personalized profile building mechanism 350, a user's ID extractor 310 within the content delivery mechanism 120, and the preference information storage 140.

The content user 130 is defined as a single content receiving destination and there may be a plurality of actual users associated with a single content receiving destination. The preference information may be associated with actual users and the preference information of a particular actual user may be identified based on some unique identification associated with the actual user.

In FIG. 3, preference information is obtained via different means. First, a user's preference information may be provided together with a request by the user. In this case, the content user 130 may interactively provide preference information through, for instance, an interactive TV 330. For example, while the content user 130 interactively specifies a desired movie through an interactive TV screen, an inquiry interface may be simultaneously displayed on the TV screen that inquiries the user's interest in the categories of advertisement that are to be sent together with the requested movie. The user may use a remote control to click on the desired categories and then send to the content delivery mechanism 120, together with the request, the selected advertisement categories as preference information. The request, coupled with the preference information, can then be passed on from the content delivery mechanism 120 to the content provider 110.

User supplied preference information may also be stored in the preference information storage 140, to which the content delivery mechanism 120 has access to. Each piece of preference information may be stored with reference to the identification of the corresponding user so that the preference information may later be retrieved based on the same identification. In FIG. 3, when the content user 130 specifies a request, the preference information associated with the same user may be automatically retrieved, from the preference information storage 140, by the content delivery mechanism 120. The retrieval may be based on the user's ID which may be, for example, extracted from the user's request by a user's ID extractor 310.

A different means to obtain preference information is, for example, through a personalized profile building mechanism 350. In this case, the personalized profile building mechanism 350 monitors the content user 130. It observes what kinds of advertisement that the content user 130 likes and estimates automatically the user's liking to generate the preference information associated with the content user 130. Such generated preference information is sent to the content delivery mechanism 120 that may subsequently store the information in the preference information storage 140 using the ID of the content user 130. The preference information such generated may be used in the same fashion as user supplied preference information. The personalized profile building mechanism 350 may also continue the generalization and dynamically update the preference information stored in the preference information mechanism 140 based on new observations.

When both the preference information stored in the preference information storage 140 and the preference information supplied by the content user are present (i.e., even though a user's preference information has been acquired and stored, the user provides on-line preference information along with a request), the content delivery mechanism 120 may adopt certain rules to determine which piece of preference information is to be used. For example, the content delivery mechanism 120 may always use on-line supplied preference information whenever it is available. When on-line preference information is provided, the content delivery mechanism 120 may also interact with the user to determine whether the on-line provided preference information is to be used to update the preference information stored in the preference information storage 140.

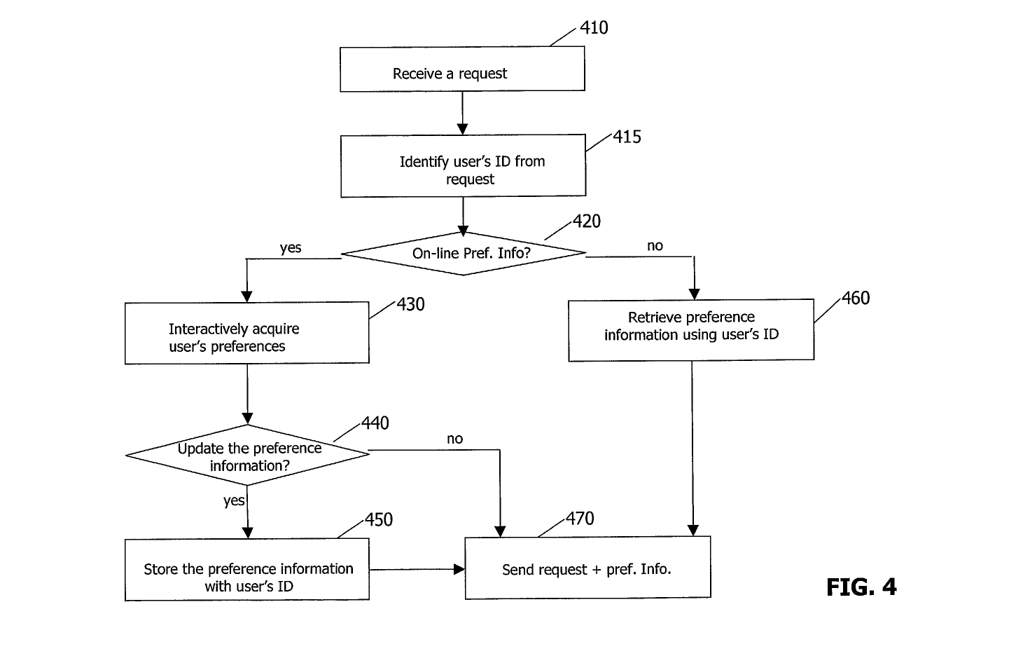

FIG. 4 is an exemplary flowchart in which the content delivery mechanism 120 acquires preference information from either the content user 130 or by retrieving pre-store preference information from the preference information storage 140. The content delivery mechanism 120 receives a request from a content user at act 410. The user's ID is embedded in the request and is extracted at act 415. At act 420, whether the preference information is to be provided on-line is determined.

If the user is to provide on-line preference information, preference information is acquired interactively at act 430. If the on-line acquired preference information is to be used to update the preference information stored in the preference information storage 140, determined at act 440, the acquired preference information is stored, at act 450, in the preference information storage 140 using the user's ID as an index.

If the on-line preference information is not provided, the extracted user's ID is used to search and retrieve, at act 460, the preference information of the user from the preference information storage 140. The obtained preference information, either through the interactive means or through retrieval, is then sent, at act 480, along with the request from the content delivery mechanism 120 to the content provider 110.

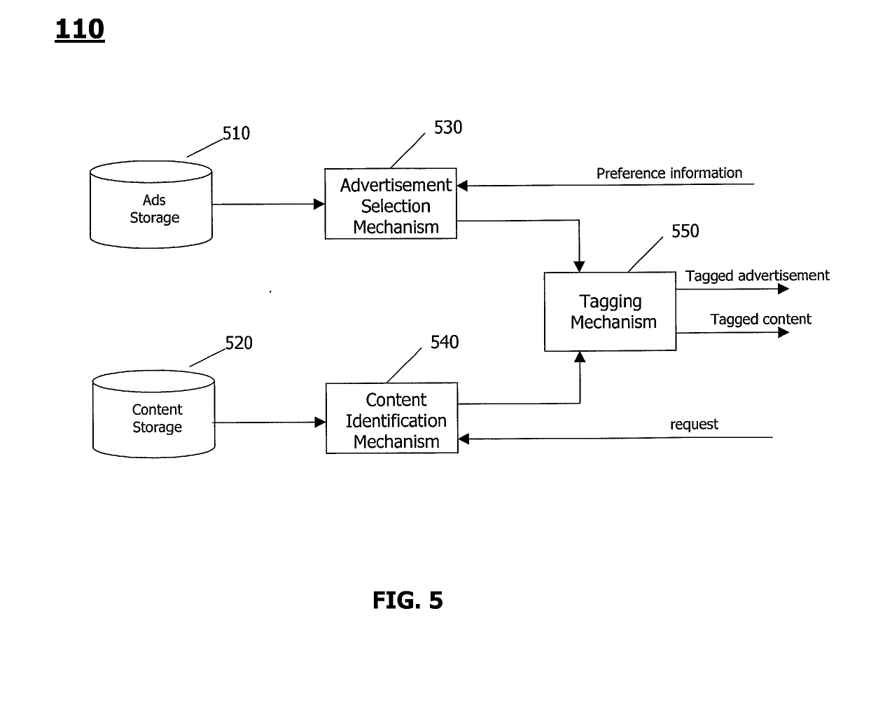

FIG. 5 is an exemplary high level block diagram of the content provider 110. System 110 in FIG. 5 comprises an advertisement storage 510, a content storage 520, a advertisement selection mechanism 530, a content identification mechanism 540, and a tagging mechanism 550.

A request, coupled with the preference information associated with the user who sends the request is processed by the content identification mechanism 540 to identify the content requested by the user. The preference information is fed to the content selection mechanism 530 so that it can be used to select the advertisements that are consistent with the user's preference. Both the content, identified by the content identification mechanism 540, and the advertisements, selected by the advertisement selection mechanism 530, are fed to the tagging mechanism 550 so that tagged content and tagged advertisements can be generated.

The content identification mechanism 540 connects to the content storage 520. Content stored in the content storage 520 may be accessed via some indexing mechanism. For example, movies may be indexed using their names. The indexing mechanism may comprise multiple layers of indices so that content can be organized into a hierarchy. For example, the content storage 520 may store different categories of content such as sports programs, news programs, movies, and education programs. Within each of such categories, there may be sub-categories. For instance, in the category of sports programs, there may be soccer games, basket ball games, and tennis games. Similarly, in the category of movies, there may be sub-categories such as western, drama, comedy, or foreign. At the lowest level of indexing, a piece of content may be indexed by, for example, the date of a sports game or the name of a movie.

The content identification mechanism 540 takes a user's request as input and identifies the content that satisfies the request. The request may be specified in accordance with the classification of the content stored in the content storage 520. In this case, the content identification mechanism 540 searches the content storage 520 for a match between the request and the classification of the content.

The advertisement selection mechanism 530 connects to the advertisement storage 510. Advertisement stored in the advertisement storage 510 may be searched via some indexing mechanism. For example, advertisements may be classified into different categories such as food advertisements, car advertisements, or medicine advertisements. Within each of such categories, there may be sub-categories of advertisement. For instance, in the category of car advertisements, there may be advertisements for sports vehicles, luxury cars, or family sedans.

The advertisement selection mechanism 530 takes preference information as input and selects advertisements that satisfy specified preference. For example, if a user's preference for advertisement includes cars and health products, only advertisements from these preferred categories are selected. The advertisement selection mechanism 530 may determine, within a preferred category, the specific advertisements based on some criteria. For example, if a user's preference includes car advertisement and the user's age falls in a group known to be more interested in sports cars, the advertisement selection mechanism 530 may choose sports car advertisements as selection results. As another example, if, in addition to choose car advertisements as preferred advertisement, a user also prefers not to watch more than three car advertisements within 10 hour period, a car advertisement should not be selected if the user has been sent three car advertisement in the last five hours.

The tagging mechanism 550 incorporates tags to the identified content and the selected advertisements. For example, for a movie chosen by the content identification mechanism 540, a tag may be attached that indicates the movie's category (e.g., western) and the movie's name. For an advertisement chosen by the advertisement selection mechanism 530, a tag may be attached to it that indicates the category of the advertisement (e.g. car) and the relevant specificity (e.g., sports car) associated with the advertisement.

Such tagging may be necessary in situations where the content provider 110 connects to a plurality of content users that may share a common network connection to the content provider 110, through which the downstream data is sent. For example, a cable company sends downstream data to a neighborhood of multiple households. In this case, different content and advertisements, requested by more than cable TVs in the neighborhood may be sent all at once through the common network connection. The tags, in this case, may be utilized by the set top box at each receiving household to ensure that each TV displays the content and advertisements that are requested. That is, the content delivery mechanism 120 filters out the content and advertisements whose tags do not match with the request issued by the user and the preference information associated with the user.

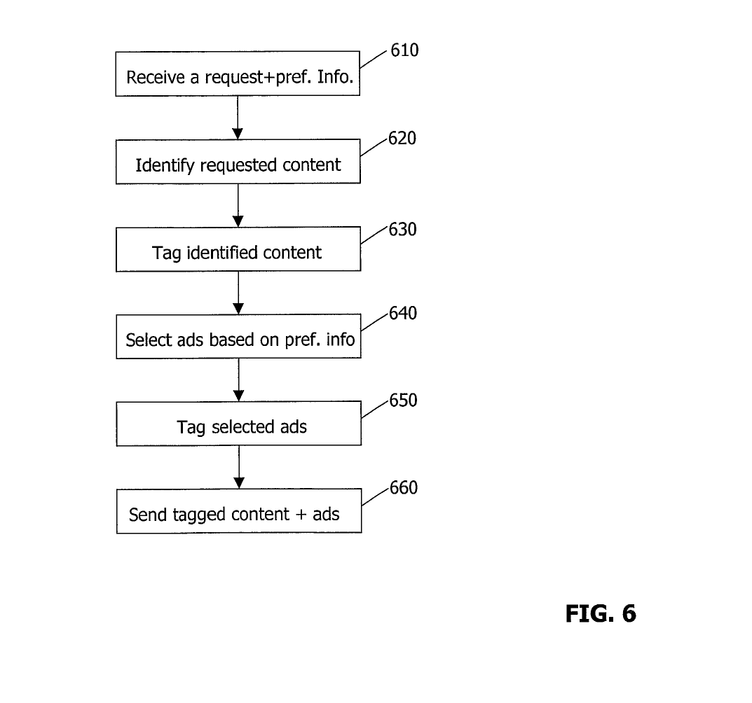

FIG. 6 is a flowchart for the content provider 110. A request from the content user 130 and the preference information associated with the content user are received at act 610. The request is analyzed by the content identification mechanism 540 and used to identify the requested content at act 620. The tagging mechanism 550 incorporates appropriate tags to the identified content at act 630. The received preference information is utilized at act 640 by the advertisement selection mechanism 530 to select advertisements that are consistent with the user's preference. The selected advertisements are tagged at act 650 by the tagging mechanism 550. At act 660, both the tagged content and tagged advertisements are sent from the content provider 110 to the content delivery mechanism 120.

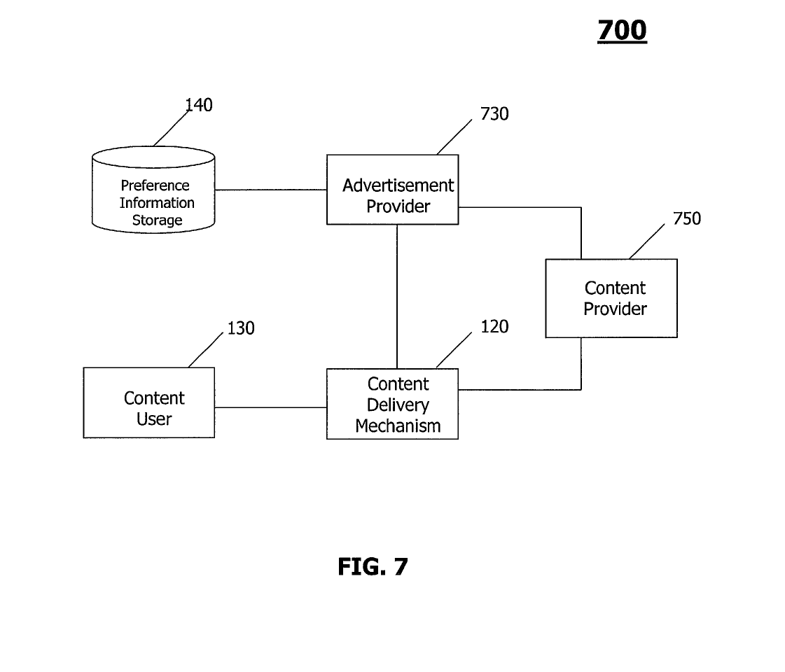

In the descriptions in referring to FIG. 1 to FIG. 6, advertisement selection is handled together with content identification by the content provider 110. Content and advertisement may be handled separately. One embodiment of the invention that enables content and advertisement to be handled separately is shown in FIG. 7. In FIG. 7, system 700 comprises the content user 130, the content delivery mechanism 120, the content provider 110, an advertisement provider 730, and the preference information storage 140. The advertisement provider 730 connects to the preference information storage 140, the content provider 110, and the content delivery mechanism 120. The content user 130 requests and receives content and advertisement via the content delivery mechanism 120.

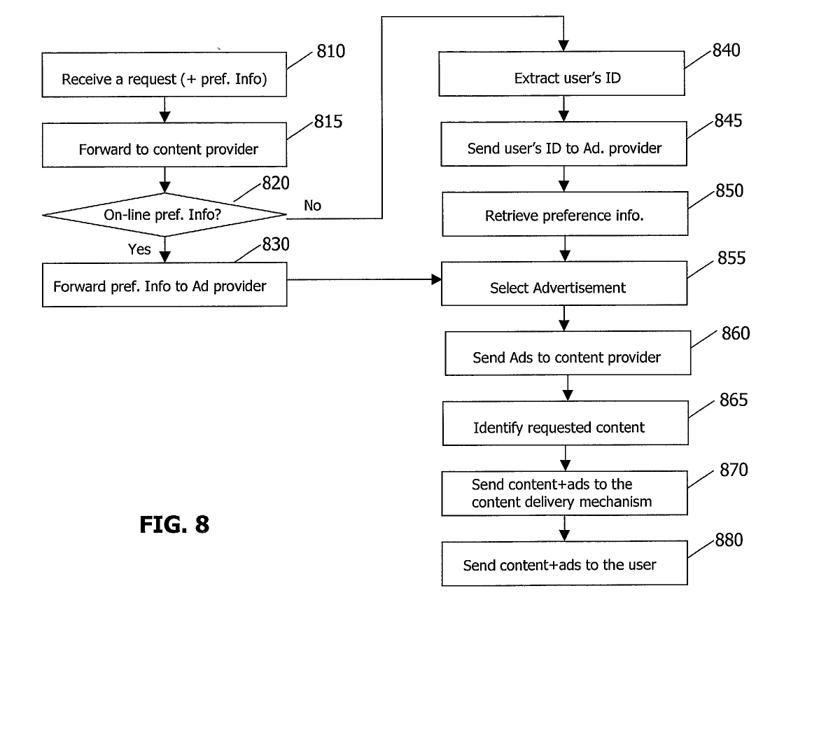

FIG. 8 is an exemplary flowchart for system 700. A request for content, issued by the content user 130, is received at act 810 by the content delivery mechanism 120. The content user 130 may also provide on-line preference information along with the request. The user's request includes user's identification information. The content delivery mechanism 120 forwards, at act 815, the received request, possibly with on-line preference information, to the content provider 110.

If on-line preference information is provided together with the request from the user, determined at act 820 by the content provider 110, the on-line preference information is forwarded, at act 830, from the content provider 110 to the advertisement provider 730. If on-line preference information is not provided, such information may be retrieved by the advertisement provider 730 based on the user's ID. In this case, the content provider 110 extracts the user's ID from the request at act 840 and sends the ID at act 845 to the advertisement provider 730.

The advertisement provider 730 retrieves the user's preference information based on the given ID information at act 850. Using the preference information, either sent by the content provider 110 as on-line preference or retrieved as pre-stored preference from the preference information storage 140, the advertisement provider 730 selects, at act 855, the advertisement that satisfies the given preference and sends, at act 860, the selected advertisements to the content provider 110.

The content provider 110 identifies, at act 865, the requested content The identified content is sent at act 870, together with the selected advertisement, from the content provider 110 to the content delivery mechanism 120. The content delivery mechanism 120 then forwards the data to the content user 130.

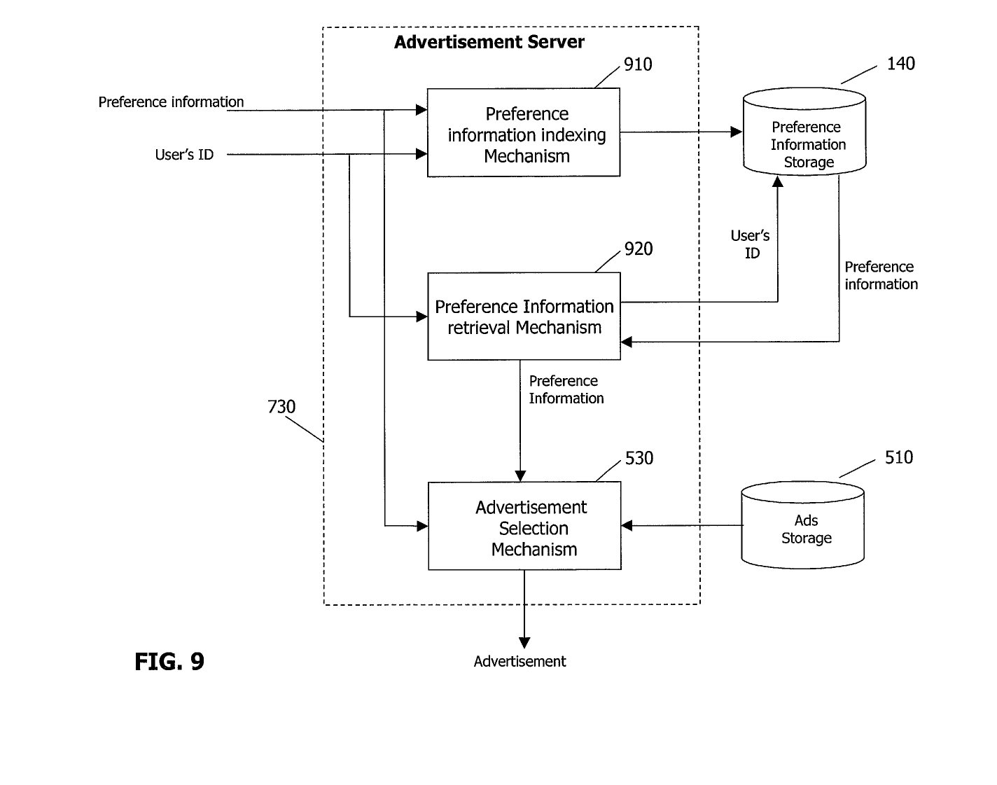

FIG. 9 presents an exemplary block diagram for the advertisement provider 730, in relation to the preference information storage 140 and the advertisement storage 510. The advertisement provider 730 comprises a preference information indexing mechanism 910, a preference information retrieval mechanism 920, and the advertisement selection mechanism 530.

The preference information indexing mechanism 910 stores given preference information using given user's ID. It may be used as a mechanism that populates the preference information storage 140 based on user provided preference information. The preference information indexing mechanism 910 may also be used on-line. For example, when a user issues a content request with on-line preference information, the preference information indexing mechanism 910 may act as an updating mechanism that takes the on-line preference information and updates the pre-stored preference information. When on-line preference information is provided, the preference information indexing mechanism 910 may also pass the on-line information directly to the advertisement selection mechanism 530 rather than activate the preference retrieval mechanism to retrieve data from the preference information storage 140.

When on-line preference information is not provided, the preference information retrieval mechanism 920 is activated. The preference information retrieval mechanism 920 takes a user's identification as input and retrieves the preference information, from the preference information storage 140, associated with the user using the identification as an index. The advertisement selection mechanism 530 takes preference information, either provided by the user as on-line preference or retrieved from the preference information storage, as input and selects the advertisements that satisfy the given preference information.

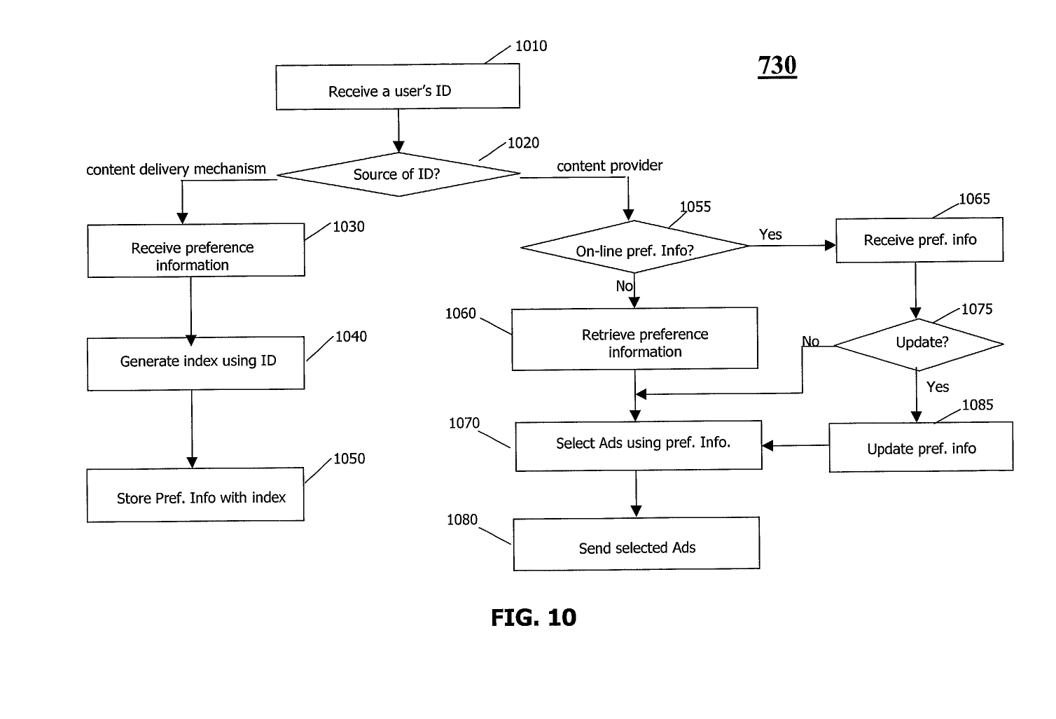

FIG. 10 shows an exemplary flowchart of the advertisement provider 730. In FIG. 10, a user's identification is received at act 1010. Depending on the source where the identification is sent, determined at act 1020, the advertisement provider 730 performs different functionality. If the identification is sent by the content delivery mechanism 120, the preference information is sent along to register the user's preference information with the advertisement provider 730. In this case, the advertisement provider 730 stores the user's preference information in the preference information storage 140 with the received ID as index. If the identification is sent from the content provider 110, it is to request the advertisement provider 730 to select advertisements for the user identified by the identification.

When the identification is sent from the content delivery mechanism 120, the advertisement provider 730 gathers the preference information sent by the content delivery mechanism 120, at act 1030. The preference information indexing mechanism 910 generates, at act 1040, an index for the preference information based on, for example, the given identification. Such index is established to facilitate future search and retrieval of the preference information. The preference information is then stored, at act 1050, with the index in the preference information storage 140.

If the identification is sent from the content provider 110, the advertisement provider 730 selects advertisements for the user, identified by the received identification, based on the user's preference information. The preference information may be provided on-line along with the user's ID by the content delivery mechanism 120 or it may need to be retrieved from the preference information storage 140. If the on-line preference information is sent with the user's ID, determined at act 1055, the advertisement provider 730 receives the preference information at act 1065. If the on-line provided on-line preference information is also to be used to update the pre-stored preference information, determined at act 1075, the preference information indexing mechanism 910 updates, at act 1085, the preference information storage 140 based on given user's ID as index.

If the on-line preference information is not provided, the advertisement provider 730 activates the preference information retrieval mechanism 920 to retrieve, at act 1060, the preference information of the user based on the received ID. With the preference information of the user available (either from on-line or from retrieval), the advertisement selection mechanism 530 determines, at act 1070, the advertisements that are consistent with the user's preference. Selected advertisement is sent, at act 1080, to the content provider 110.

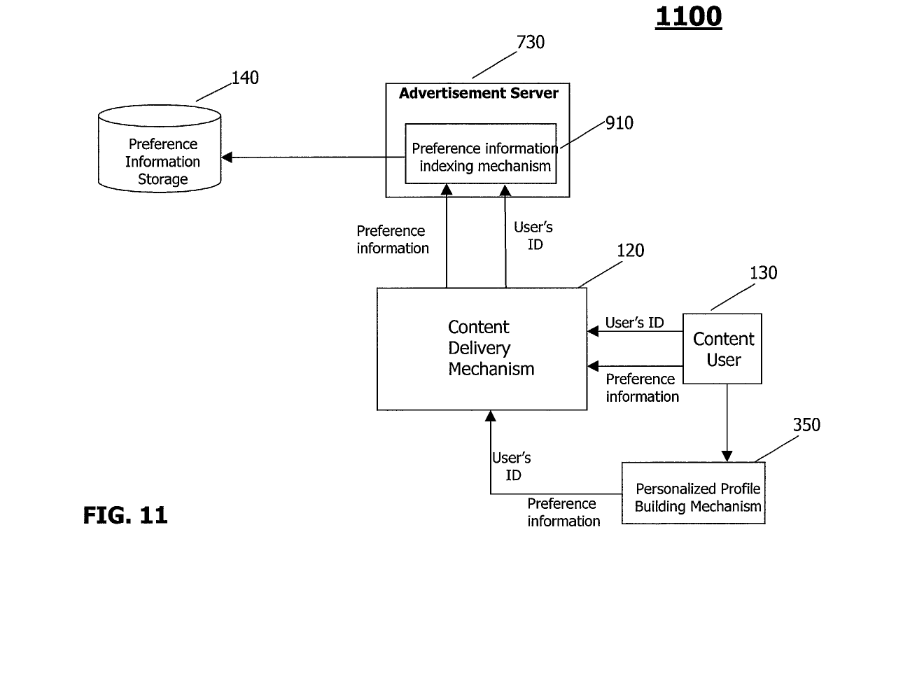

FIG. 11 is a high level block diagram that shows how users' preference information may be registered in the advertisement provider 730. In FIG. 11, two exemplary means to gather preference information are illustrated. One is to gather preference information directly from the content user 130. That is, the user specifies preference information. The specification may be acquired off-line or on-line via an interactive acquisition process. For example, a list of advertisement categories may be displayed on a screen and a content user may use a device such as a mouse or a remote control to select the categories of interests. The user's ID is sent along with the selections to the content delivery mechanism 120 and subsequently may be sent to the advertisement provider 730.

A different method to collect preference information may be through the personalized profile building mechanism 350. A user's preference is, in this case, estimated by the personalized profile building mechanism 350 by monitoring or observing the pattern in which the user views advertisements. For example, if a user often downloads web pages about cars, the personalized profile building mechanism 350 may observe that and infer that the user may like any advertisement related to cars, including advertisements about cars and automotive. Such inferred preference information may be sent, along with the user's ID, to the content delivery mechanism 120 so that it can be indexed and stored in the preference information storage 140. The personalized profile building mechanism 350 may be constructed as part of the content delivery mechanism 120.

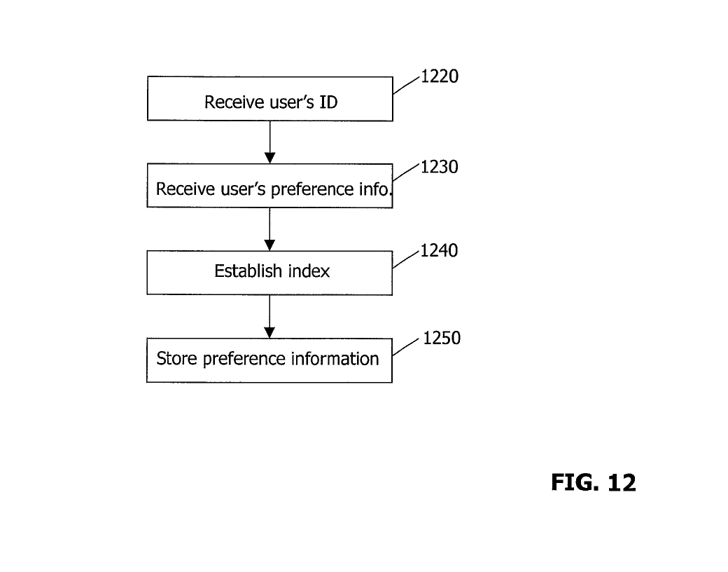

FIG. 12 describes an exemplary flowchart for collecting preference information. An ID is first received at act 1220 that corresponds to a content user. The preference information of the user is received at act 1230. As described, the preference information may be gathered via different means. Based on received ID and the preference information, an index is established at act 1240 by the preference information indexing mechanism 910. Together with the index, the preference information is then stored, at act 1250, in the preference information storage 140.

The processing described above may be performed by a general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method for buying, selling, and marketing advertisement, said method comprising:
receiving, by a content delivery mechanism, tagged content with tagged advertisement sent by a content provider; and
sending said tagged content and said tagged advertisement to a content user.

2. The method according to claim 1, wherein
said content delivery mechanism includes a set top box;
said content provider includes a TV broadcaster; and
said content provider includes a cable company.

3. The method according to claim 1, further comprising:
receiving a request, by said content delivery mechanism, from a user, said request identifying said user;
obtaining, by said content delivery mechanism, preference information associated with said user; and
transmitting said request and said preference information to said content provider before said receiving tagged content.

4. The method according to claim 3, wherein
said request includes a request for a TV program on a TV channel;
said obtaining said preference information includes obtaining the preference information supplied by said user; and
said obtaining said preference information includes obtaining the preference information by retrieving said preference information from a storage that stores pre-recorded preference information of said user.

5. The method according to claim 4, wherein said retrieving from a storage includes retrieving from a storage residing on said content delivery mechanism.

6. The method according to claim 3, wherein
said preference information includes information indicating the interest of said user about certain types of advertisement; and
said preference information including information indicating the desired frequency for said user to receive certain types of advertisement.

7. The method according to claim 4, wherein said retrieving from a storage comprises:
determining the identification of said user based on said request; and
accessing said preference information of said user from said storage based on said identification.

8. The method according to claim 3, wherein said sending comprises:
selecting content from said tagged content based on said request of the user;
selecting advertisement from said tagged advertisement based on said preference information of the user; and
deiverying said content and said advertisement to said user.

9. A method for acquiring a user's preference information, said method comprising:
registering a user via a content delivery mechanism; and
acquiring, by said content delivery mechanism, preference information of said user.

10. The method according to claim 9, further comprising storing said preference information, acquired by said acquiring, in a storage, said preference information being accessable and retrievable from said storage.

11. The method according to claim 9, wherein
said acquiring includes acquiring said preference information from said user via an interactive TV; and
said acquiring includes acquiring said preference information of said user through a personal profile building mechanism.

12. A method for a content provider to select an advertisement, said method comprising:
receiving, by a content provider from a content delivery mechanism, a request of a user, specifying desired content, with associated preference information of said user, indicating said user's preference with respect to advertisement;
selecting advertisement according to said preference information;
identifying content requested by said request;
tagging said content and said advertisement to produce tagged content and tagged advertisement; and
transmitting said tagged content and said tagged advertisement to said content delivery mechanism.

13. A method for buying, selling, and marketing advertisement, said method comprising:
receiving a request for content, by a content delivery mechanism, from a user, said request identifying said user, said request identifying said user;
transmitting, by said content delivery mechanism, said request of said user and an identification of said user to a content provider; and
receiving, by said content provider from an advertisement provider, an advertisement, selected by said advertisement provider based on preference information associated with said user.

14. The method according to claim 13, wherein
said content delivery mechanism includes an Internet Service Provider;
said request includes a request for a web page;
said identification of said user includes a cookie; and
said content provider includes a web server.

15. The method according to claim 13, wherein said receiving an advertisement comprises:
receiving, by said content provider from a content delivery mechanism, said request and an associated identification identifying a user;
identifying the content requested by said user through said request;
forwarding said identification to said advertisement provider; and
receiving, by said content provider from said advertisement provider, an advertisement selected by said advertisement provider based on said preference information.

16. The method according to claim 15, further comprising sending, by said content provider, said content, identified by said identifying, and said advertisement, received from said advertisement provider, to said content delivery mechanism.

17. A method for an advertisement provider, said method comprising:
receiving, by said advertisement provider from a content provider, an identification identifying a user;
obtaining preference information associated with said user based on said identification;
selecting an advertisement that is consistent with said preference information of said user; and
sending said advertisement to said content provider.

18. The method according to claim 17, wherein
said obtaining preference information includes obtaining said preference information from a content delivery mechanism that acquires said preference information from said user;
said obtaining preference information includes obtaining said preference information by retrieving said preference information from a storage that stores pre-recorded preference information of said user;
said preference information includes the information indicating the interest of said user about certain types of advertisement; and
said preference information includes the information indicating the desired frequency for said user to receive certain types of advertisement.

19. The method according to claim 18, wherein said retrieving from a storage includes retrieving from a storage residing on said advertisement provider.

20. The method according to claim 17, further comprising storing said preference information based on said identification prior to said obtaining preference information.

21. A method for acquiring a user's preference information, said method comprising:
registering a user, with an advertisement provider, via a content delivery mechanism; and
gathering said preference information of said user; and
sending said preference information of said user and an identification of said user to said advertisement provider.

22. The method according to claim 21, wherein
said gathering includes gathering the preference information of said user supplied by said user; and
said gathering said preference information includes gather through a personalized profile building mechanism.

23. A system for buying, selling, and marketing advertisement, said system comprising:
a content user, said user specifying a request for desired content;
a content delivery mechanism for gathering preference information, with respect to advertisement, of said content user and delivering content, requested by said content user via said request, with an advertisement, selected according to said preference information, to said content user;
a preference information storage for storing said preference information, said preference information stored in said preference information storage being accessible and retrievable to said content delivery mechanism; and
a content provider for providing said content, coupled with an advertisement, to said content user via said content delivery mechanism, said advertisement being selected, by said content provider based on said preference information of said content user, sent by said content delivery mechanism to said content provider.

24. The system according to claim 23, wherein said
content delivery mechanism includes a set top box;
content provider includes a broadcaster; and
content provider includes a cable operating company.

25. A system for a content provider, said system comprising:
a content storage for storing content;
a content identification mechanism for identifying content, requested by a content user, from said content storage;
an advertisement storage for storing advertisements;
a advertisement selection mechanism for selecting an advertisement, from said advertisement storage, based on preference information of said user, sent to said content provider from a content delivery mechanism; and
a tagging mechanism for tagging said content, identified by said content identification mechanism, and said advertisement, selected by said advertisement selection mechanism.

26. A system for buying, selling, and marketing advertisements, said system comprising:
a content user, said user specifying a request for desired content;
a content delivery mechanism for gathering preference information, with respect to advertisement, of said content user and delivering content, requested by said content user via said request, with an advertisement, selected according to said preference information, to said content user;
a preference information storage for storing the preference information;
an advertisement provider for providing an advertisement, selected based on said preference information of said content user, retrieved from said preference information storage; and
a content provider for providing said content requested by said content user via said request, coupled with an advertisement, selected by said advertisement provider based on said preference information of said content user, to said content user via said content delivery mechanism.

27. The system according to claim 26, wherein said
content delivery mechanism includes an internet service provider; and
content provider includes a web server.

28. A system for an advertisement provider, said system comprising:
a preference information indexing mechanism for storing preference information of a content user, with respect to advertisement, using the ID of said content user as an index, into a preference information storage;
a preference information retrieval mechanism for retrieving said preference information from said preference information storage using the ID of said content user;
an advertisement storage for storing advertisements; and
an advertisement selection mechanism for selecting an advertisement based on said preference information.
